(19) United States
(12) Patent Application Publication
(10) Pub. No.: US 2024/0428121 A1
(43) Pub. Date: Dec. 26, 2024

(54) Artificial Intelligence Sports Play Assisted Coaching Display Device

(71) Applicant: Cedric Daniel Thomas, Vancouver, WA (US)

(72) Inventor: Cedric Daniel Thomas, Vancouver, WA (US)

(21) Appl. No.: 18/338,268

(22) Filed: Jun. 20, 2023

(51) Int. Cl. G06N 20/00; A63B 71/06

(52) U.S. Cl. CPC G06N 20/00; A63B 71/0622

(57) ABSTRACT

A wearable electronic device that uses artificial intelligence, trained to recognize the play calls, formations, team roles, player audibles and player position changes. This device is worn by every role on a team. On command from a responsible party, it will generate a display for the play call and individual player expectations to the individual players. Each device has its own identifiable ID and functions according to the role of the individual wearer from coaches to players. The commands can be audio, visual or text. Artificial intelligence interprets commands and communicates with each player's device on the team which then displays the change to the formation or play and highlights the individual player's expectations matching the role of the receiving device. The device may give GPS feedback for statistics and utilize cloud processing. The devices communicate using 4G, 5G or any cellular technology method not yet discovered.

### BACKGROUND OF THE INVENTION

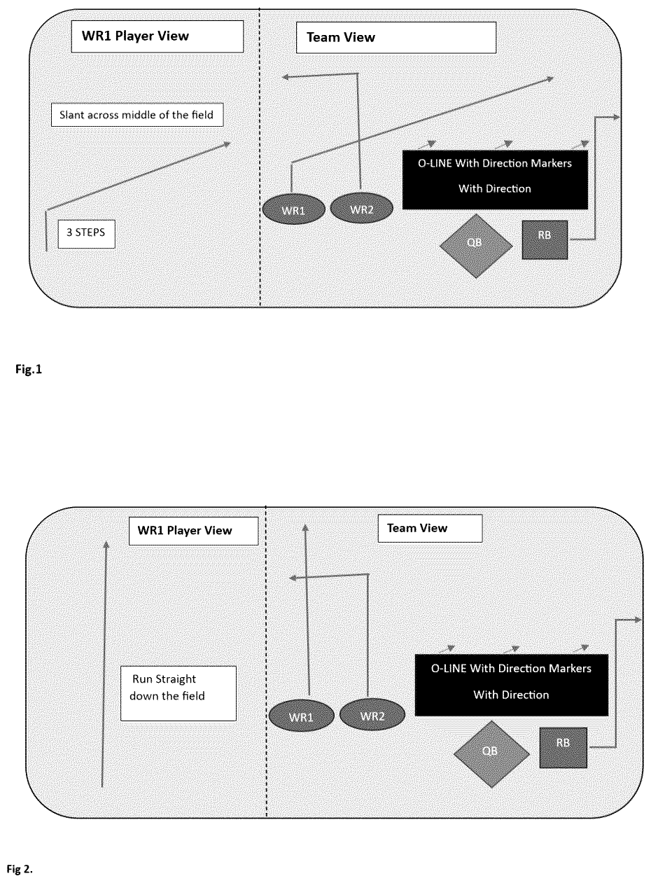

The invention is a group of devices, numbering a minimum of two, where they communicate together based on the role of each device and depicts the change in the role or position of the player wearing the device based on a command from a responsible party. The devices use artificial intelligence to recognize and generate displays of formations, play calls, player positions, player roles and expected actions. The device could also display useful team information like player names and jersey numbers. The artificial intelligence algorithm is trained to match commands, like words, visuals, or texts to plays in a playbook belonging to a team or individual, using machine learning techniques like tensor flow and other machine learning packages, or whichever is conducive for space saving and RAM efficiency. An example of this in practice would be an NFL game where the coach speaks into his device a specific play call on offense and the play shows up on each individual player's device and highlights their individual expected action. An example of what that would look like for a wide receiver running a slant route is shown in FIG. 1

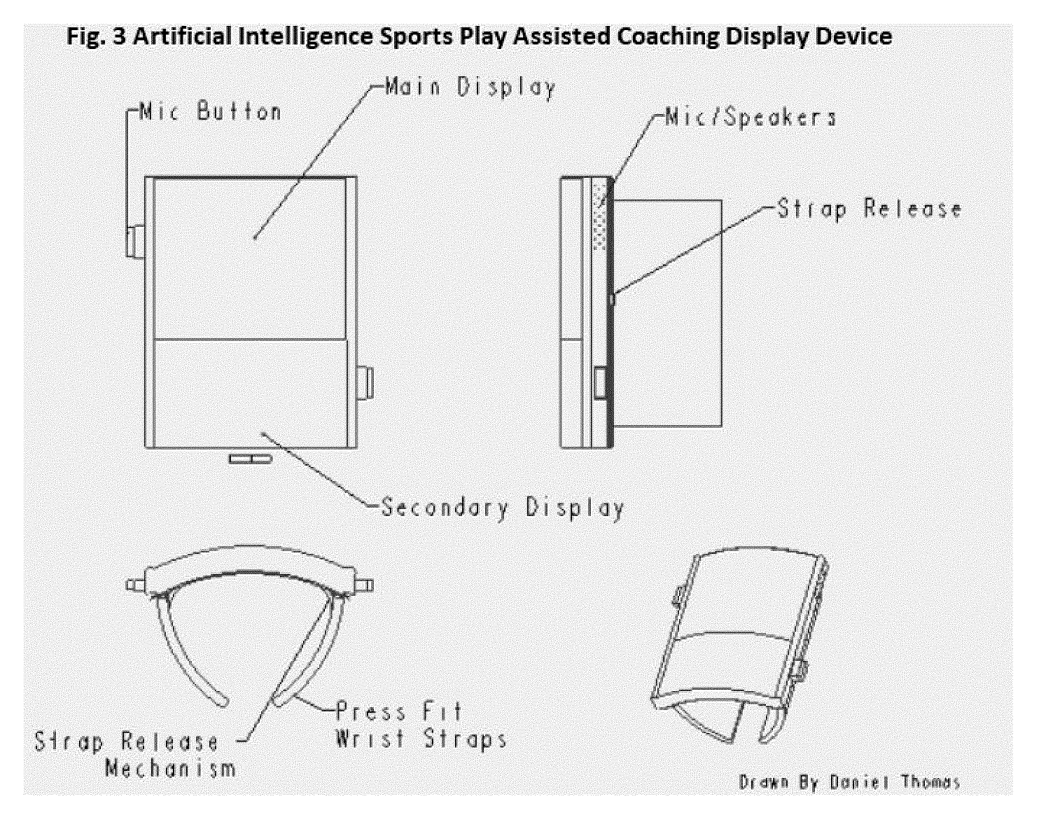

In the FIG. 1 scenario, the quarterback sees something in the middle of the field and presses the receiver button on his wearable device to begin changing the play. He only wants to change the route of WR1. He speaks a phrase like “WR1 go route” or “Wide receiver Mclaurin run straight down the field” or “Number 17 run straight” and the artificial intelligence algorithm should understand and interpret the words the Quarterback is saying and update the route and overall look of the play on everyone's device in the team view but only the affected player sees in a change in their “Player's View”. The updated generated display of the team view and players view is shown in FIG. 2.

The screen is split into two sections where the player's expected actions “Player View” is shown in one and the team's overall expected actions “Team View” is shown in another. The Artificial intelligence algorithm should also be able to relay pertinent information to individual the player like whether they should expect the ball or any special details it was trained to expect that might come from the quarterback.

The device can also be trained to learn what plays to suggest based on opposing team actions. The device can also potentially be connected to a GPS system within the stadium or venue to give real time information statistics and matchup feedback to the coaches.

### Parts

Parts should include but are not limited to, a screen made of some durable glass that can withstand high force impacts, electronic components comprising of a printed circuit board, a mic, a speaker and other components to enable functionality, a durable casing for electronic components, padding material under where the device makes contact with the human for shock absorption, a strap mechanism that stays in place when closed inwards to fit the wearer and is released upon pressing a button. The specific design of the strap may or may not require a separate patent not listed in this description. The process seeks to establish how artificial intelligence is used to interpret commands for actions associated with team sports and responding by generating a display, picture, video, or audio representation of plays, formations, audibles, route changes or any action related to team sports where the positioning and actions of players can be displayed for a user wearing the device relative to their required actions.

### Communication

The artificial intelligence algorithm is created and trained separately then installed onto the devices. The devices should utilize a version of an embedded-SIM or some other unique identifier to communicate via a private network within the venue limit outside interference and maximize the ability for control over live activities. In the absence of a private network the device can utilize cellular network communication to communicate to the devices. The artificial intelligence installed on the processor of each device may require cloud processing if adequate processing power is unavailable and the results sent back to each machine where it is interpreted and then a display is generated for the user of the device. The means by which signals from one electronic device to another device must be interpret by artificial intelligence to generate a correct digital representation of the commands and play calls are not limited solely to, symbols, letters, numbers, video, audio, or any combination of the aforementioned.

### Manufacturing Process

The manufacturing process for this device should follow best known practices for manufacturing electronic devices and the manufacturer or assembly facility chosen. Parts can be sourced from manufactured components already on the market except for the screen, strap mechanism and the casing for the components. These may require further research and development if market components are not satisfactory to withstand impact forces at a suitable price. Display for screen should be a minimum of 1080P.

1: The action of training artificial intelligence using software packages or any machine learning techniques to recognize sports plays, formations, audibles, defensive and offensive schemes and expected actions while playing team sports,

2: A device that uses artificial intelligence trained to interpret commands for plays and formations associated with teams sports from another similar device or remote location,

3: A wearable device that uses artificial intelligence to generate images and depictions of expected actions, based on commands from a responsible party or actions learned from machine learning in response to opposition actions using real time in game data, to relay to the players individually while playing team sports,

4: A wearable device using artificial intelligence or some other coded means to change the expected action of a player or group of players, in a team sports play generated image, video or animation, that is generated on a wearable device worn by individual players, and depict the changes in a new image, video or animation.

5: Using cloud computing or remote computing to interpret and relay expected player actions to wearable devices in the form of images, videos or animations during team sports and using artificial intelligence to collect or interpret individual player-based GPS location actions and sports statistics.
